(19) United States
(12) Patent Application Publication
(10) Pub. No.: US 2013/0140428 A1
(43) Pub. Date: Jun. 6, 2013

(54) MOLD CORE AND METHOD FOR MANUFACTURING THE MOLD CORE

(71) Applicant: HON HAI PRECISION INDUSTRY CO., LTD., Tu-Cheng (TW)

(72) Inventor: SHAO-KAI PEI, Tu-Cheng (TW)

(73) Assignee: HON HAI PRECISION INDUSTRY CO., LTD., Tu-Cheng (TW)

(21) Appl. No.: 13/626,044

(22) Filed: Sep. 25, 2012

(30) Foreign Application Priority Data
Dec. 1, 2011 (TW) 100144184

(51) Int. Cl. B28B 7/36; B28B 7/38

(52) U.S. Cl. 249/114.1; 427/133; 427/135

(57) ABSTRACT

A method for manufacturing a mold core includes the following steps: providing a body having a forming surface; forming an iridium dioxide layer preform on the forming surface to obtain a mold core preform; and reducing iridium dioxide of a surface of the iridium dioxide layer preform into iridium, so that the iridium dioxide layer preform is converted to an iridium dioxide layer and an iridium layer formed on the iridium dioxide layer to obtain the mold core.

### BACKGROUND

1. Technical Field

The present disclosure generally relates to mold cores and methods for manufacturing a mold core, and particularly to a mold core for making a glass sheet and a method for manufacturing the mold core.

2. Description of Related Art

Mold cores used for making glass sheets need to have good detachability, mechanical strength and chemical stability, so a protection film is required to be formed on a surface of a body of the mold core. The body of the mold core is usually made of stainless steel, tungsten carbide (WC), or silicon carbide (SiC). The protection film is usually made of noble metal, such as platinum-iridium (Pt-Ir) alloy, iridium (Ir) alloy, or ruthenium (Ru) alloy. The protection film is deposited on the surface of the body usually by physical vapor deposition (PVD) method. However, a sputtering target of the noble metal used in the PVD method is expensive, so a cost for manufacturing the mold core is high.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present disclosure. Moreover, in the drawings like reference numerals designate corresponding parts throughout the several views. Wherever possible, the same reference numerals are used throughout the drawings to refer to the same or like elements of an embodiment.

FIG. 1 shows a cross-sectional view of a mold core of one embodiment.

FIG. 2 is a flowchart showing a method for manufacturing the mode core of FIG. 1.

FIG. 3 shows a cross-sectional view of a preform of the mold core of FIG. 1.

FIG. 4 shows an XPS spectrum of Ir 4f in a surface of a mold core of a first example.

FIG. 5 shows an XPS spectrum of Ir 4f in a surface of a mold core of a second example.

FIG. 6 shows an XPS spectrum of Ir 4f in a surface of a mold core of a third example.

### DETAILED DESCRIPTION

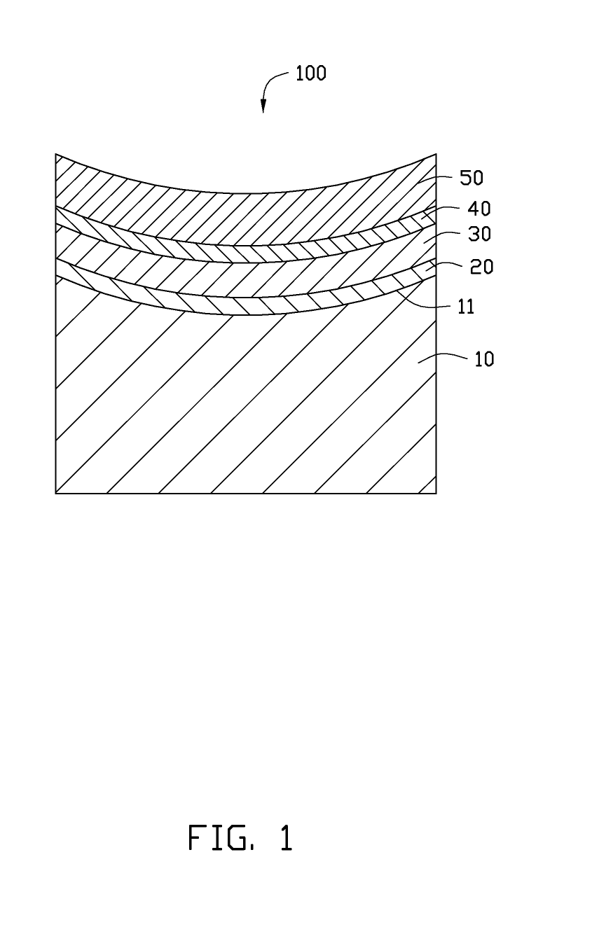

Referring to FIG. 1, an embodiment of a mold core 100 used for making a glass sheet (not shown) is illustrated. The mold core 100 includes a body 10, a tungsten carbide (WC) layer 20, a titanium (Ti) layer 30, an iridium dioxide (IrO₂) layer 40, and an iridium (Ir) layer 50. The body 10 includes a forming surface 11. The WC layer 20 is formed on the forming surface 11. The Ti layer 30 is formed on the WC layer 20. The IrO₂ layer 40 is formed on the Ti layer 30. The Ir layer 50 is formed on the IrO₂ layer 40.

In the illustrated embodiment, the body 10 is made of stainless steel. The WC layer 20, the Ti layer 30, and the IrO₂ layer 40 can be made by PVD methods or plasma enhanced chemical vapor deposition (PECVD) methods. The Ir layer 50 is formed by reducing an IrO₂ layer preform, and a part of the IrO₂ layer preform forms the IrO₂ layer 40. A thicknesses of the WC layer 20 is in a range from about 100 nanometers (nm) to about 500 nm. A thickness of the Ti layer 30 is in a range from about 100 nm to about 500 nm. A thickness of the IrO₂ layer 40 is in a range from about 100 nm to about 500 nm. A thickness of the Ir layer 50 is in a range from about 100 nm to about 500 nm.

In an alternative embodiment, the body 10 can be made of high temperature ceramic materials, such as WC or SiC, or high temperature graphite materials. Thicknesses of the above mentioned layers can be changed to suit the glass sheet being formed or other manufacturing conditions. If a binding force between the IrO₂ layer 40 and the body 10 can reach a usage need, the WC layer 20 and the Ti layer 30 can be omitted, and the IrO₂ layer 40 can be formed directly on the forming surface 11.

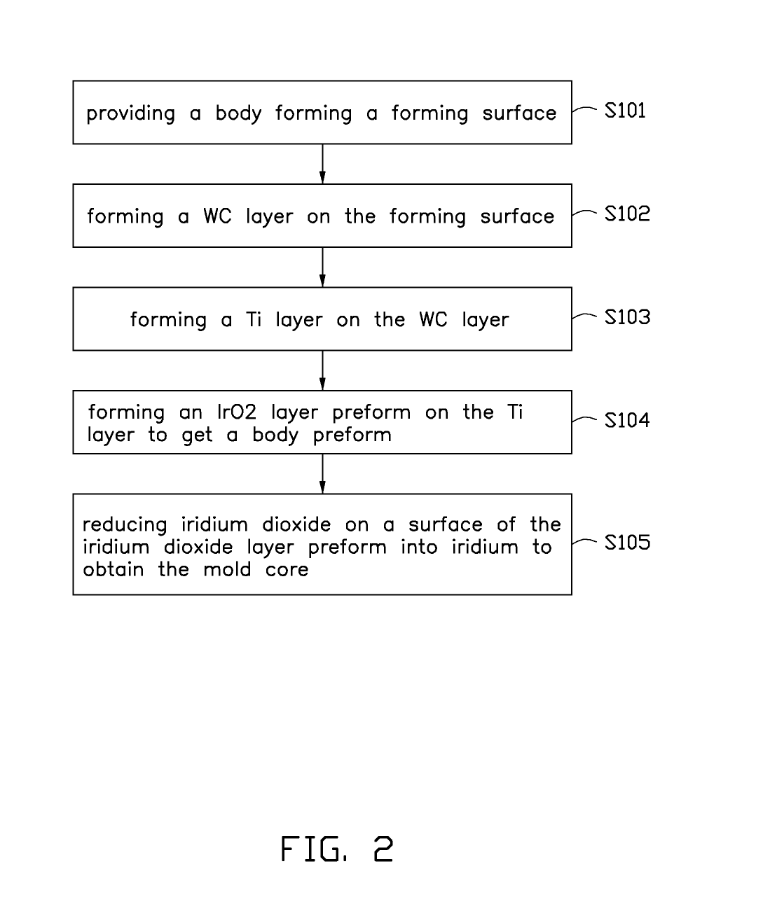

Also referring to FIG. 2, an embodiment of a method for manufacturing the mold core of the embodiment is illustrated as follows.

In step S101, a body 10 is provided. The body 10 includes a forming surface 11. The body 10 can be made of high temperature ceramic materials, such as

WC or SiC, or high temperature graphite materials. In an illustrated embodiment, the body 10 is made of stainless steel, so the body 10 has high mechanism strength and a long lifespan.

In step S102, a WC layer 20 is deposited on the forming surface 11. The WC layer 20 can be deposited by PVD methods or PECVD methods. In the illustrated embodiment, the WC layer 20 is deposited by a PVD method. A thickness of the WC layer 20 is in a range from about 100 nm to about 500 nm. In other embodiments, the thickness of the WC layer 20 can be changed as manufacturing methods or materials of the glass sheet being formed.

In step S103, a Ti layer 30 is deposited on the WC layer 20. The Ti layer 30 can be deposited by PVD methods or PECVD methods. In the illustrated embodiment, the Ti layer 30 is deposited by a PVD method. A thickness of the Ti layer 30 is in a range from about 100 nm to about 500 nm. In other embodiments, the thickness of the Ti layer 30 can be changed with the manufacturing methods or the materials of the glass sheet being formed.

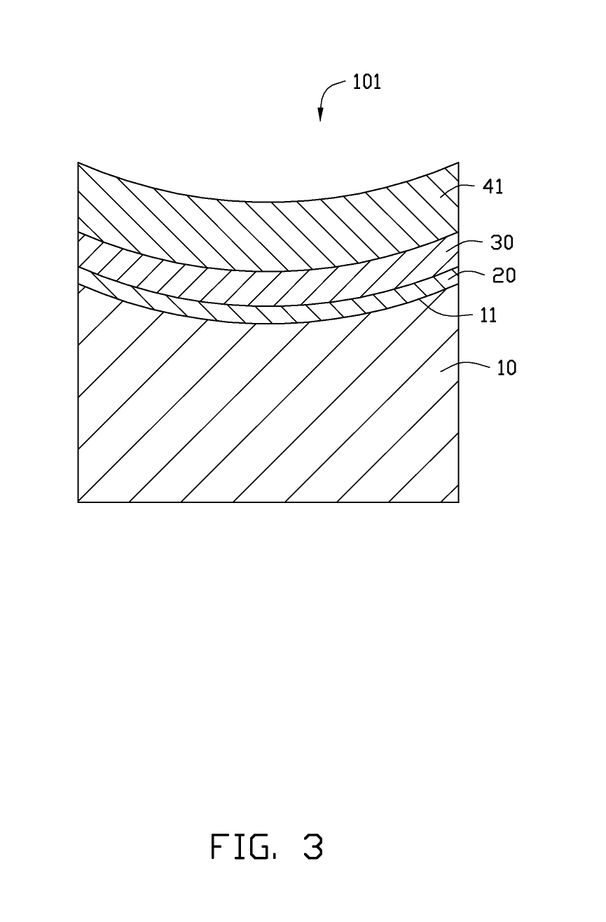

In step S104, referring also to FIG. 3, an IrO₂ layer preform 41 is deposited on the Ti layer 30 to get a body preform 101. The IrO₂ layer preform 41 can be deposited by PVD methods or PECVD methods. In the illustrated embodiment, the IrO₂ layer preform 41 is deposited by a PVD method. A thickness of the IrO₂ layer preform 41 is in a range from about 500 nm to about 1000 nm. In other embodiments, the thickness of the IrO₂ layer preform 41 can be changed with the manufacturing methods or the materials of the glass sheet being formed.

In step S105, IrO₂ of a surface of the IrO₂ layer preform 41 is reduced, so that the IrO2 layer preform 41 is converted into the IrO₂ layer 40 and the Ir layer 50 deposited on the IrO₂ layer 40. In the illustrated embodiment, the IrO₂ layer preform 41 is reduced by a thermal decomposition method. In the embodiment, the IrO₂ layer preform 41 is heated to a temperature equal to or higher than about 500 degrees Celsius for about 30 minutes (min) to about 120 min, keeping a pressure equal to or lower than about 1.33×10⁻⁴ Pascal (Pa). IrO₂ of the surface of the IrO₂ layer preform 41 is decomposed into Ir and Oxygen (O₂), so that the IrO₂ layer 40 and the Ir layer 50 are obtained. A thickness of the IrO₂ layer 40 is in a range from about 100 nm to about 500 nm. A thickness of the Ir layer 50 is in a range from about 100 nm to about 500 nm. In other embodiments, other methods can be employed to reduce the IrO₂ layer preform 41, such as a method of reacting IrO₂ of the surface of the IrO₂ layer preform 41 with a reducing gas. The reducing gas can be hydrogen (H₂) or ethyne (C₂H₂).

During the manufacturing process of the mold core 100 of the embodiment, the IrO₂ layer preform 41 is formed in advance. And then the Ir layer 50 is formed by reducing IrO₂ of the surface of the IrO2 layer preform 41, so an Ir sputtering target with a high cost, which is needed when forming the Ir layer 50 directly, can be omitted. Thus, a manufacturing cost of the mold core is low. Furthermore, a binding force between the IrO₂ layer 40 and the Ir layer 50 is high, so that the usage life of the mold core 100 is prolonged. In addition, crystal lattices of the WC layer 20, the Ti layer 30, the body 10, and the IrO₂ layer 40 are similar, the WC layer 20 and the Ti layer 30 are formed between the body 10 and the IrO₂ layer 40, so binding forces between the above mentioned layers and the body 10 is improved, which further prolongs the lifespan of the mold core 100.

In other embodiments, if a binding force between the IrO₂ layer 40 and the body 10 can reach a usage need, the WC layer 20 and the Ti layer 30 can be omitted, and the IrO₂ layer 40 can be formed directly on the forming surface 11.

An example 1 of the method for manufacturing the mold core of the embodiment is as follows.

In a first step, a body made of stainless steel is provided. The body includes a forming surface.

In a second step, a WC layer is deposited on the forming surface by a vacuum sputtering process. Parameters of the vacuum sputtering process of the example 1 are as follows. A sputtering target is tungsten (W) target; a reacting gas is C₂H₂, and a flow velocity of C₂H₂ is about 60 standard-state cubic centimeter per minute (sccm); a radio frequency power is about 200 watts; a pressure is equal to or lower than about 1.33 Pa, and a sputtering time is about 400 seconds. A thickness of the WC layer is about 100 nm.

In a third step, a Ti layer is deposited on the WC layer by a vacuum sputtering process. Parameters of the vacuum sputtering process of the example 1 are as follows.

A sputtering target is Ti target; a protection gas is argon (Ar), and a flow velocity of Ar is about 30 sccm; a radio frequency power is about 200 watts; a pressure is equal to or lower than about 1.33 Pa, and a sputtering time is about 150 seconds. A thickness of the Ti layer is about 200 nm.

In a fourth step S104, an IrO₂ layer preform is deposited on the Ti layer to get a body preform by a vacuum sputtering process. Parameters of the vacuum sputtering process of the example 1 are as follows. A sputtering target is IrO₂ target; a plurality of reacting gases are Ar and O₂, a flow velocity of Ar is about 20 sccm, and a flow velocity of O₂ is about 80 sccm; a direct current power is about 200 watts; a pressure is equal to or lower than about 0.9 Pa; a temperature is about 200 degrees Celsius; and a sputtering time is about 300 seconds. A thickness of the IrO₂ layer preform is about 600 nm.

In a fifth step, IrO₂ of a surface of the IrO2 layer preform is reduced. The body preform is heated to about 550 degrees Celsius for about 60 minutes, keeping a pressure equal to or lower than about 1.33×10⁻⁴ Pa and a nitrogen flow with a flow velocity of 100 sccm. IrO₂ of a surface of the IrO2 layer preform is decomposed into Ir and O₂, an Ir layer is formed on an IrO₂ layer, so that the mold core is obtained. A thickness of the IrO₂ layer is about 150 nm. A thickness of the Ir layer is about 450 nm.

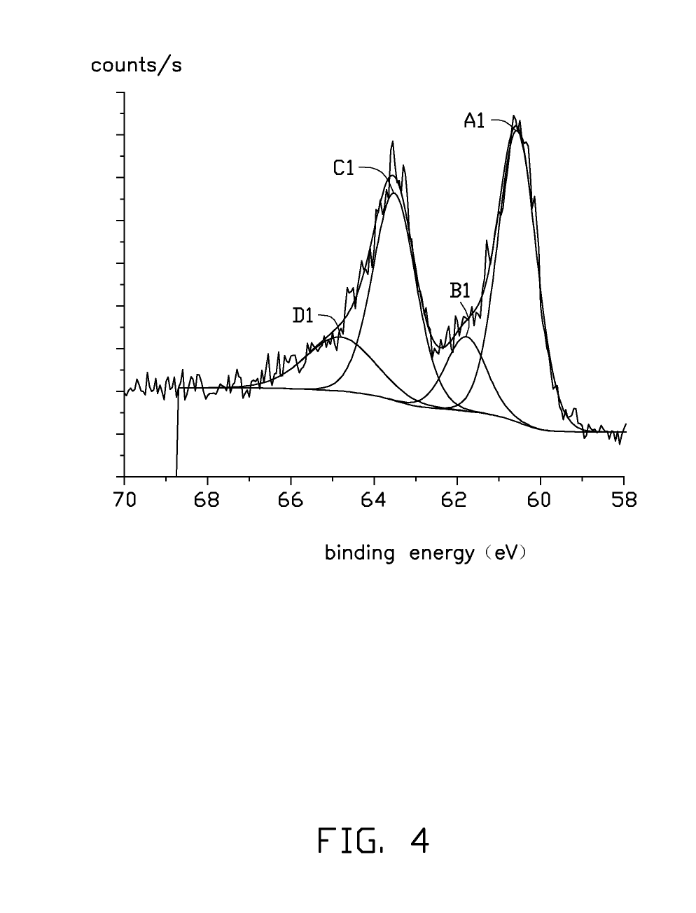

As shown in FIG. 4, the successful reduction of IrO₂ of the surface of the IrO2 layer preform is demonstrated by the XPS experiments. The signals at peak A1 and peak C1 of 4f_{7/2} and 4f_{5/2} (about 60.5 eV and about 63.5 eV) exhibit essentially identical binding energies for the Ir 4f orbit in accord with Ir⁰. The signals at peak B1 and peak D1 of Ir 4f_{7/2} and Ir 4f_{5/2} (about 61.7 eV and about 64.7 eV) exhibit essentially identical binding energies for the Ir 4f orbit in accord with Ir⁴⁺.

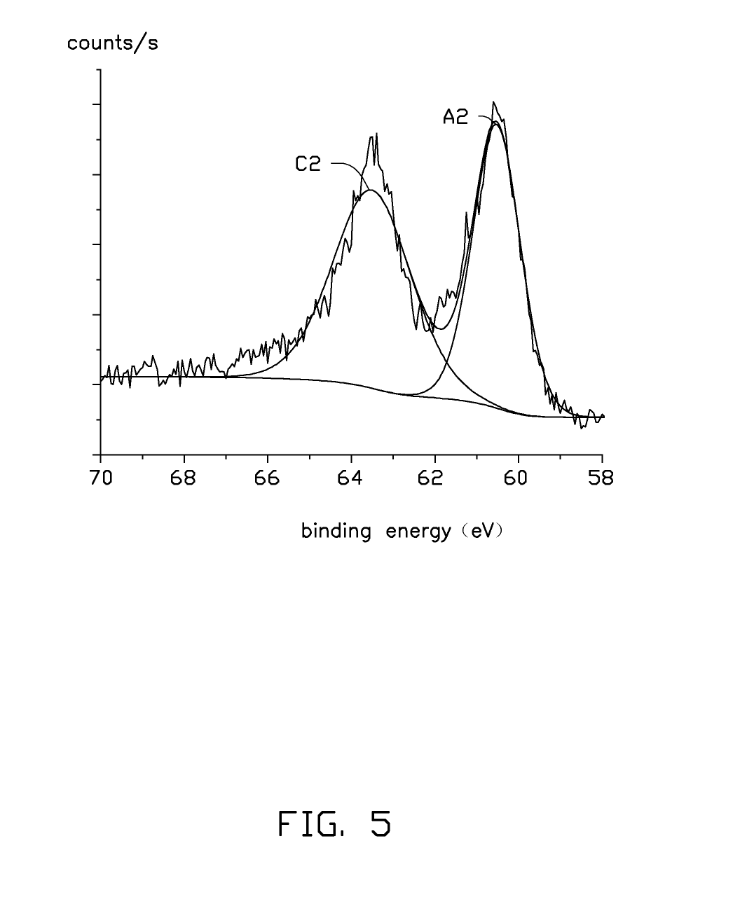

An example 2 of the method for manufacturing the mold core of the embodiment is similar to the example 1 of the method for manufacturing the mold core of the embodiment. However, for the example 2, in a fifth step, the preform is heated to about 550 degrees Celsius for about 90 minutes to reduce IrO₂ of the surface of the IrO2 layer preform. A thickness of the IrO₂ layer is about 100 nm. A thickness of the Ir layer is about 500 nm. As shown in FIG. 5, the signals at peak A2 and peak C2 of 4f_{7/2} and 4f_{5/2} (about 60.5 eV and about 63.5 eV) exhibit essentially identical binding energies for the Ir 4f orbit in accord with Ir⁰. Signals exhibiting identical binding energies for the Ir 4f orbit in accord with Ir⁴⁺ are not distinct, which suggests a content of the IrO₂ is relatively low in the surface of the mold core.

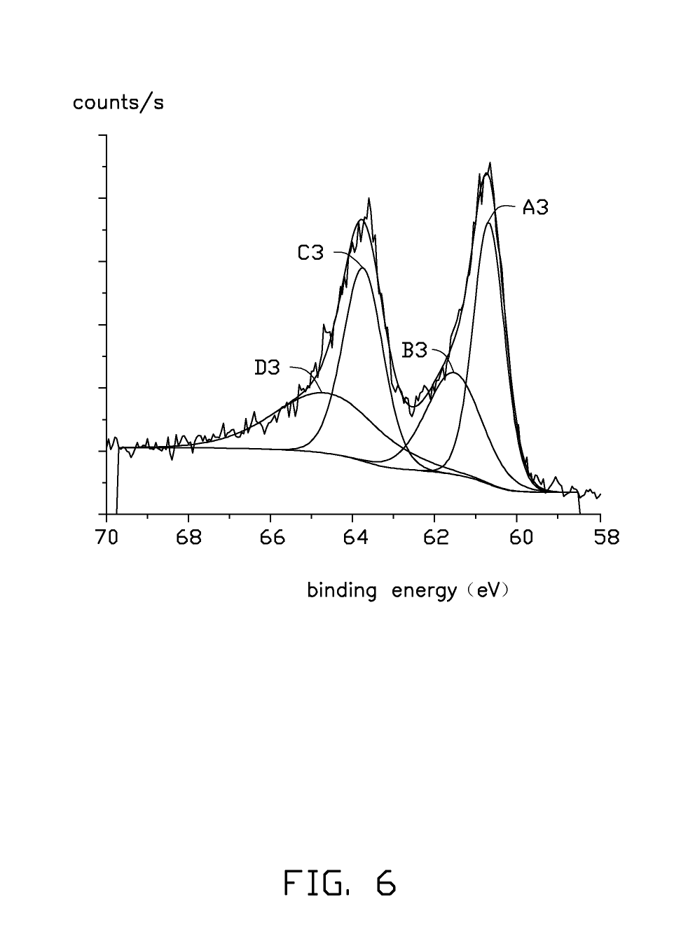

An example 3 of the method for manufacturing the mold core of the embodiment is similar to the example 1 of the method for manufacturing the mold core of the embodiment. However, for the example 3, in a fifth step, the preform is heated to about 600 degrees Celsius for about 60 minutes to reduce IrO₂ of the surface of the IrO2 layer preform. A thickness of the IrO₂ layer is about 150 nm. A thickness of the Ir layer is about 450 nm. As shown in FIG. 6, the signals at peak A3 and peak C3 of 4f_{7/2} and 4f_{5/2} exhibit essentially identical binding energies for the Ir 4f orbit in accord with Ir⁰. The signals at peak B3 and peak D3 of Ir 4f_{7/2} and Ir 4f_{5/2} exhibit essentially identical binding energies for the Ir 4f orbit in accord with Ir⁴⁺.

It is to be understood, however, that even through numerous characteristics and advantages of the disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A mold core, comprising a body having a forming surface, an iridium dioxide layer formed on the forming surface, and an iridium layer formed on the iridium dioxide layer.

2. The mold core of claim 1, wherein a tungsten carbide layer or/and a titanium layer is formed between the forming surface and the iridium dioxide layer in that order.

3. The mold core of claim 1, wherein the body is made of a material selected from a group consisting of stainless steel, high temperature ceramic materials, and high temperature graphite materials.

4. The mold core of claim 1, wherein the body is made of a material selected from a group consisting of tungsten carbide and silicon carbide.

5. A mold core, comprising:
a body made of a material selected from a group consisting of stainless steel, high temperature ceramic materials, and high temperature graphite materials, wherein the body comprises a forming surface;
a tungsten carbide layer or a titanium layer formed on the forming surface in that order;
an iridium dioxide layer formed on the tungsten carbide layer or the titanium layer; and
an iridium layer formed on the iridium dioxide layer.

6. A method for manufacturing a mold core, comprising steps as follows:
providing a body forming a forming surface;
forming an iridium dioxide layer preform on the forming surface to obtain a mold core preform; and
reducing iridium dioxide of a surface of the iridium dioxide layer preform into iridium, so that the iridium dioxide layer preform is converted to an iridium dioxide layer and an iridium layer formed on the iridium dioxide layer to obtain the mold core.

7. The method for manufacturing a mold core of claim 6, wherein iridium dioxide of the surface of the iridium dioxide layer preform is reduced by a thermal decomposition method.

8. The method for manufacturing a mold core of claim 7, wherein iridium dioxide of the surface of the iridium dioxide layer preform is reduced at a temperature equal to or higher than about 500 degrees Celsius for about 30 minutes to about 120 minutes.

9. The method for manufacturing a mold core of claim 8, wherein iridium dioxide of the surface of the iridium dioxide layer preform is reduced at about 550 degrees Celsius for about 60 minutes to about 90 minutes.

10. The method for manufacturing a mold core of claim 8, wherein iridium dioxide of the surface of the iridium dioxide layer preform is reduced at about 600 degrees Celsius for about 60 minutes.

11. The method for manufacturing a mold core of claim 6, further comprising forming a tungsten carbide layer or/and a titanium layer between the forming surface and the iridium dioxide layer perform in that order.

12. The method for manufacturing a mold core of claim 11, wherein the tungsten carbide layer or/and the titanium layer is deposited between the forming surface and the iridium dioxide layer preform by a vacuum sputtering process in that order.

13. The method for manufacturing a mold core of claim 6, wherein iridium dioxide of the surface of the iridium dioxide layer preform is reduced by hydrogen.

14. The method for manufacturing a mold core of claim 6, wherein the iridium dioxide layer preform is deposited on the forming surface by a vacuum sputtering process.

15. The method for manufacturing a mold core of claim 6, wherein the body is made of a material selected from a group consisting of stainless steel, high temperature ceramic materials, and high temperature graphite materials.

16. The method for manufacturing a mold core of claim 15, wherein the body is made of a material selected from a group consisting of tungsten carbide and silicon carbide.
